(19) United States
(12) Patent Application Publication
(10) Pub. No.: US 2025/0216608 A1
(43) Pub. Date: Jul. 3, 2025

(54) TECHNOLOGIES FOR MICRO-LED OPTICAL COMMUNICATION VIA GLASS WAVEGUIDES

(71) Applicants: Benjamin T. Duong, Phoenix, AZ (US); Khaled Ahmed, San Jose, CA (US); Kristof Darmawikarta, Chandler, AZ (US); Stephen Morein, San Jose, CA (US); Bai Nie, Chandler, AZ (US)

(72) Inventors: Benjamin T. Duong, Phoenix, AZ (US); Khaled Ahmed, San Jose, CA (US); Kristof Darmawikarta, Chandler, AZ (US); Stephen Morein, San Jose, CA (US); Bai Nie, Chandler, AZ (US)

(21) Appl. No.: 18/399,416

(22) Filed: Dec. 28, 2023

(51) Int. Cl. G02B 6/125; G02B 6/12

(52) U.S. Cl. CPC G02B 6/125; G02B 6/12004; G02B 2006/12038; G02B 2006/12104; G02B 2006/12123

(57) ABSTRACT

Technologies for micro-LED optical communication via glass waveguides are disclosed. In an illustrative embodiment, a glass interposer is mounted on a circuit board, and several integrated circuit (IC) dies are positioned above the glass interposer. A micro-LED assembly is mounted on each of the IC dies. Waveguides defined in the glass interposer can carry light between the micro-LED assemblies of the various IC dies, providing a high-bandwidth connection between the IC dies. The micro-LED assemblies can provide low-power, high-bandwidth connectivity between the IC dies and can operate in the high-temperature environment near the IC dies.

### BACKGROUND

As computing power increases, the bandwidth requirement likewise increases for communication over short distances, such as for communication between dies on the same circuit board or between circuit boards near each other. Copper traces and other electrical conductors are commonly used to carry high-bandwidth signals, but as frequencies increase, copper traces have more loss. In some cases, the loss for high-frequency signals can be significant even for dies adjacent to each other on the same circuit board.

### BRIEF DESCRIPTION OF THE DRAWINGS

FIG. 1 is an isometric view of an integrated circuit component with two integrated circuit dies with micro-LED assemblies connected by waveguides.

FIG. 2 is a cross-sectional view of one embodiment of one of the integrated circuit components of FIG. 1.

FIG. 3 is a cross-sectional view of one embodiment of one of the integrated circuit components of FIG. 1.

FIG. 4 is a cross-sectional view of one embodiment of one of the integrated circuit components of FIG. 1.

FIG. 5 is a cross-sectional view of one embodiment of one of the integrated circuit components of FIG. 1.

FIG. 6 is a simplified flow diagram of at least one embodiment of a method for manufacturing a system for chip-to-chip communication with microLEDs and microphotodiodes.

FIG. 7 is a top view of a wafer and dies that may be included in a microelectronic assembly, in accordance with any of the embodiments disclosed herein.

FIG. 8 is a cross-sectional side view of an integrated circuit device that may be included in a microelectronic assembly, in accordance with any of the embodiments disclosed herein.

FIGS. 9A-9D are perspective views of example planar, gate-all-around, and stacked gate-all-around transistors.

FIG. 10 is a cross-sectional side view of an integrated circuit device assembly that may include a microelectronic assembly, in accordance with any of the embodiments disclosed herein.

FIG. 11 is a block diagram of an example electrical device that may include a microelectronic assembly, in accordance with any of the embodiments disclosed herein.

### DETAILED DESCRIPTION

In various embodiments disclosed herein, an integrated circuit component includes semiconductor dies and a glass interposer. A micro-light-emitting diode (micro-LED) assembly is adjacent to each semiconductor die and the glass interposer. The micro-LED assembly may include micro-LEDs and/or photodetectors to send and/or receive optical data. The micro-LED assemblies are coupled to waveguides defined in the glass interposer. The waveguides in the glass interposer connect the micro-LED assemblies adjacent to the various semiconductor dies. The short distance from the circuitry on the semiconductor die to the micro-LED assembly can carry a relatively high-frequency signal with relatively low loss. The micro-LED assembly can operate at the elevated temperatures that may occur near the front side of the semiconductor dies, and the micro-LED assembly can operate at a low energy-per-bit level.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicate via an embedded bridge in a package substrate and an integrated circuit component attached to a printed circuit board that send signals to or receives signals from other integrated circuit components or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

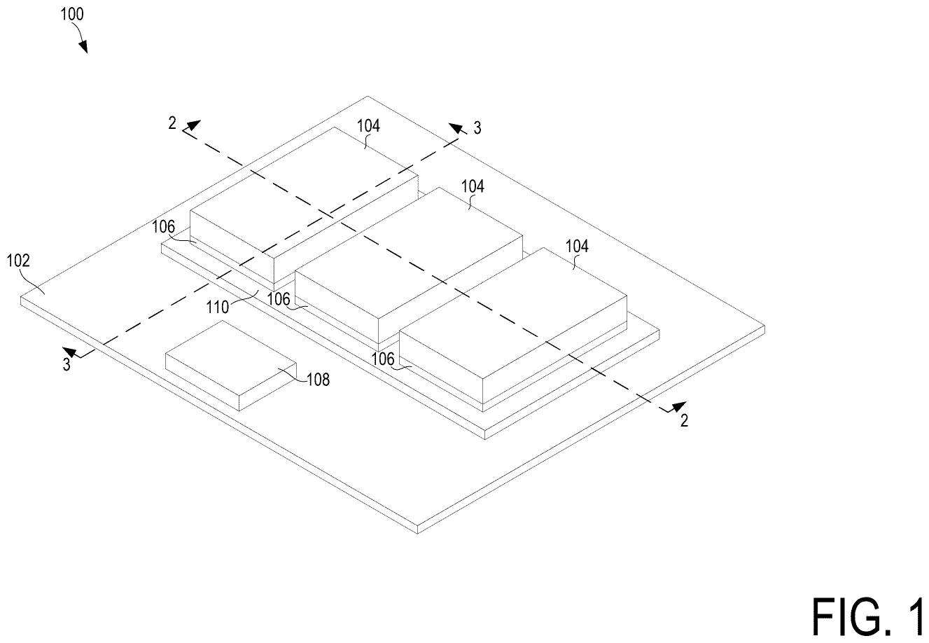

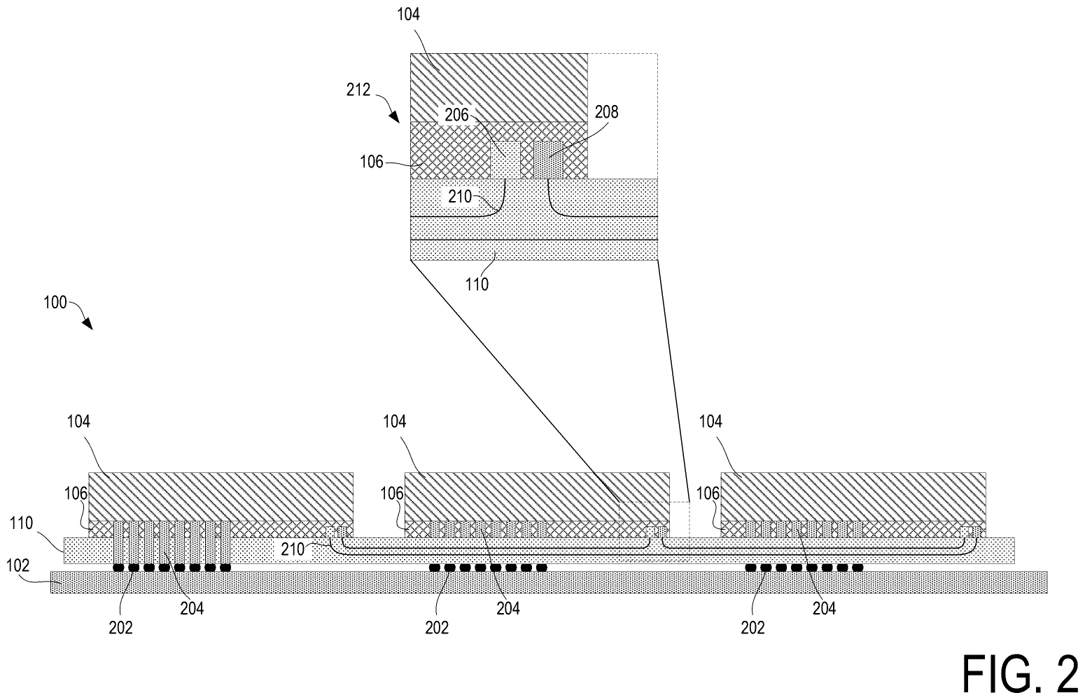

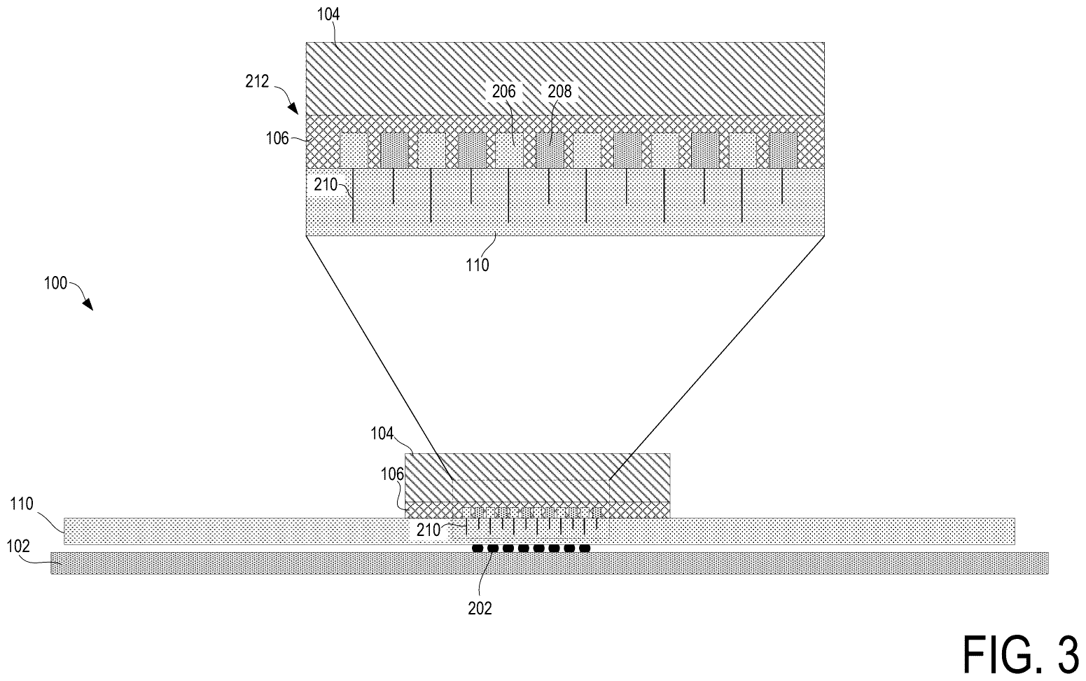

Referring now to FIGS. 1-3, in one embodiment, an integrated circuit component 100 includes a circuit board 102, a glass interposer 110, and several integrated circuit (IC) dies 104 mounted above the glass interposer 110. FIG. 1 shows a perspective view of an integrated circuit component 100, FIG. 2 shows a cross-sectional view of one embodiment of the integrated circuit component 100 showing several IC dies 104, and FIG. 3 shows a cross-sectional view of one embodiment of the integrated circuit component 100 showing another perspective of an IC die 104.

In an illustrative embodiment, a base die 106 of each of several micro-LED assemblies 212 is mounted on glass interposer 110, and the IC dies 104 are each mounted on a corresponding base die 106 of a micro-LED assembly 212. Circuitry, such as transistors, capacitors, resistors, etc., are on the front side of the die 104, facing the circuit board 102. Vias 204 extend through the glass interposer 110 and each base die 106, connecting the IC dies 104 to the circuit board 102. The micro-LED assembly 212 is mounted on the front side of the IC die 104 and is connected to the IC die 104 by, e.g., bump bonding, hybrid bonding, and/or the like. In an illustrative embodiment, the micro-LED assembly 212 includes a base die 106, one or more micro-LEDs 206, and one or more photodetectors 208. Optical waveguides 210 are defined in the glass interposer 110. The optical waveguides 210 are aligned with the micro-LED dies 206 and/or the photodetector dies 208.

In use, the micro-LED assembly 212 is connected to transistors, micro-LED driver circuitry, photodetector driver circuitry, etc., on the front side of the IC die 104. High-speed input/output (HSIO) data signals can be sent from the circuitry on the front side of the IC die 104 to and from the micro-LED assembly 212 with relatively high frequency and relatively low loss, such as sending signals at a frequency up to 1-32 gigahertz with a loss of less than 0.1-10 dB. In an illustrative embodiment, signals are sent to and received from the micro-LED assembly 212 at a frequency up to about 32 gigahertz with a loss of less than 3 dB. Electrical signals sent from the circuitry on the front side of the IC die 104 are converted by a micro-LED die 206 to an optical signal, which is coupled to the waveguides 210 in the glass interposer 110. The optical signal is transported to the micro-LED assembly 212 connected to another IC die 104. The optical signal is then converted back to an electrical signal at a photodetector die 208, and the electrical signal is sent to the circuitry on the front side of the IC die 104. In this manner, HSIO signals can be sent between the IC dies 104 with relatively low loss. The IC dies 104 may be any suitable distance apart, such as 0.025-100 millimeters.

The illustrative circuit board 102 may be made from ceramic, glass, and/or organic-based materials with fiberglass and resin, such as FR-4. The circuit board 102 may have any suitable length or width, such as 10-500 millimeters. The circuit board 102 may have any suitable thickness, such as 0.2-5 millimeters. The circuit board 102 may support additional components besides the components shown in FIGS. 1-3, such as additional photonic or electronic integrated circuit components, a memory device, additional circuit components, etc.

The circuit board 102 may have an organic or inorganic core, such as an organic core of resin and fiberglass or an inorganic core, such as a glass core. A glass core of the circuit board 102 may be any suitable material, such as any embodiment of the glass interposer 110 described below.

The glass interposer 110 may be made of any suitable material that may be crystalline, non-crystalline, amorphous, etc., such as fused silicon, borosilicate, sapphire, yttrium aluminum garnet, etc. The glass core may be, e.g., aluminosilicate glass, borosilicate glass, alumino-borosilicate glass, silica, fused silica. The glass core may include one or more additives, such as Al2O3, B2O3, MgO, CaO, SrO, BaO, SnO2, Na2O, K2O, SrO, P2O3, ZrO2, Li2O, Ti, and Zn. The glass core may comprise silicon and oxygen, as well as any one or more of aluminum, boron, magnesium, calcium, barium, tin, sodium, potassium, strontium, phosphorus, zirconium, lithium, titanium, and zinc. The glass core may include at least 20-40 percent silicon by weight, at least 20-40 percent oxygen by weight, and at least 5 percent aluminum by weight. For example, some embodiments of the glass core may include, e.g., at least 20-23 percent silicon and at least 20-26 percent oxygen by weight. The glass interposer 110 may have any suitable length or width, such as 10-500 millimeters. The glass interposer 110 may have any suitable thickness, such as 0.2-5 millimeters. The glass interposer 110 may extend the full length and/or width of the circuit board 102, or the glass interposer 110 may be smaller than the circuit board 102.

The vias 204 may extend through any suitable height, such as through the entire glass interposer 110 and/or base die 106. The vias 204 may be filled with any suitable conductive material, such as copper, tungsten, conductive polymers, polysilicon, and/or the like. The vias 204 may be made up of through-glass vias that extend through the glass interposer 110 and through-silicon vias that extend through the base die 106. The vias in the base die 106 may connect to the vias in the glass interposer 110 in any suitable manner, such as by using solder balls, bump bonding, hybrid bonding, etc. In general, the various components, such as the glass interposer, base die 106, IC die 104, micro-LED dies 206, photodiode dies 208, etc., may be connected in any suitable manner, such as using bump bonding, hybrid bonding, epoxy, a combination thereof, and/or the like. The vias 204 may extend straight up from the circuit board 102 to the IC die 104, or the vias 204 extend through the glass interposer 110 at one position and be routed to another position through traces on the glass interposer 110. The vias 204 may carry any suitable signal, such as high-speed input/output signals and/or power signals.

The one or more IC dies 104 may include any suitable electronic integrated circuit component, such as resistors, capacitors, inductors, transistors, etc. The one or more IC dies 104 may include any suitable analog and/or digital circuitry, such as a processor, a memory, an application-specific integrated circuit (ASIC), a field-programmable gate array (FPGA), a router, a modem, communication circuitry, a motherboard, a daughterboard, a mezzanine board, an auxiliary board, etc. The IC dies 104 may have any suitable length or width, such as 1-300 millimeters. The IC dies 104 may have any suitable thickness, such as 0.05-5 millimeters.

The integrated circuit component 100 may include other components, such as additional IC dies 108, components such as capacitors, inductors, voltage regulators, etc. In an illustrative embodiment, the glass interposer 110 is mounted on the circuit board 102 with solder balls 202 that are connected to the vias 204. In various embodiments, the glass interposer 110 may be mounted on the circuit board 102 using a ball grid array, a land grid array, flip-chip bonding, and/or the like.

In an illustrative embodiment, the micro-LED assembly 212 includes a base die 106, one or more micro-LED dies 206, and one or more photodetector dies 208. The base die 106 may be a silicon semiconductor die. In other embodiments, the base die 106 may be another type of die, such as glass, a III-V semiconductor die composing, e.g., boron, aluminum, gallium, indium, nitrogen, phosphorus, arsenic, tin, etc. The base die 106 may include one or more through-silicon (or through-substrate) vias, traces, pads, etc. The base die 106 may include one or more layers of traces. In an illustrative embodiment, driver circuitry for the micro-LED dies 206 and/or the photodetector dies 208 are on the front side of the IC die 104. In some embodiments, the base die 106 may include driver circuitry for the micro-LED dies 206 and/or the photodetector dies 208.

The micro-LEDs 206 may be any suitable micro-LED, such as gallium nitride micro-LEDs 206, quantum dot LEDs, single nanowire LED, etc. As used herein, a micro-LED refers to a light-emitting diode with a length and width of a light-emitting surface of less than 100 micrometers. In some embodiments, the length and/or width of a light-emitting surface of the micro-LEDs 206 may be smaller, such as less than 10-50 micrometers. In the illustrative embodiment, the micro-LEDs 206 are created on a separate substrate and transferred to the base die 106, the IC die 104, or other dies.

The micro-LED 206 may have any suitable wavelength, such as 380-1,500 nanometers, depending on the particular material and structure of the micro-LED 206. In the illustrative embodiment, the micro-LED 206 may be between, e.g., 400-450 nanometers. The micro-LED 206 may have any suitable bandwidth, such as 1-15 nanometers.

In one embodiment, the photodiodes 208 may be similar to or the same as the micro-LEDs 206, with an opposite bias to detect light rather than create it. The photodiodes 208 may be made from any suitable materials, such as silicon, silicon-germanium (SiGe), a III-V material including those listed above for the micro-LEDs 206, etc. In some embodiments, the photodiodes 208 may be microphotodiodes 208. As used herein, a microphotodiode 208 refers to a photodiode with a length and width of a light-sensitive surface of less than 100 micrometers. In some embodiments, the length and/or width of a light-sensitive surface of the microphotodiodes 208 may be smaller, such as less than 10-50 micrometers. Similar to the micro-LEDs 206, the photodiodes 208 may be created on a separate substrate and transferred to the base die 106. In some embodiments, the photodiodes 208 may be able to be used as micro-LEDs 206 and/or the micro-LEDs 206 may be able to be used as photodiodes 208. In the illustrative embodiment, each micro-LED 206 and microphotodiode 208 interfaces with the die 106 on which they are mounted through a copper pad on the die 106 and a transparent electrode on top of the micro-LED 206 or microphotodiode 208. The transparent electrode may be any suitable transparent conductive material, such as indium tin oxide (ITO). The micro-LEDs 206 and/or photodiodes 208 may be secured to the base die 106 in any suitable manner, such as by using solder, hybrid bonding, etc.

In the illustrative embodiment, the photodiodes 208 are spaced apart from other photodiodes 208 and/or from micro-LEDs 206 in order to prevent cross-talk. The photodiodes 208 and/or micro-LEDs 206 may be spaced apart by, e.g., 10-500 micrometers, as measured from the center of one photodiode 208 and/or micro-LED 206 to the next. In some embodiments, the photodiodes 208 may be responsive to a similar wavelength range as a corresponding micro-LED 206, and different micro-LEDs 206 may have different wavelength ranges.

In the illustrative embodiment, each micro-LED 206 has a corresponding photodiode 208 next to it on the same die 106, creating a transmit/receive pair. In other embodiments, a die 106 may have more receive channels or more transmit channels. Each micro-LED 206 and photodiode 208 is connected to a drive and receive circuit, respectively, that interfaces with other electronic components of the base die 106 and/or IC die 104. The micro-LED assembly 212 may include any suitable number of micro-LEDs 206 and/or photodiodes 208, such as 1-10,000. Each micro-LED 206 may transmit, and each photodiode 208 may receive data at a rate of, e.g., 1-128 gigabits per second. In the illustrative embodiment, the IC die 104 sends data by modulating the micro-LED 206 at different amplitudes, such as on and off. Any suitable encoding may be used, such as return-to-zero encoding, non-return-to-zero encoding, amplitude shift keying, multilevel amplitude shift keying, pulse amplitude modulation, phase shift keying, quadrature amplitude modulation, etc. In the illustrative embodiment, data can be transferred by a micro-LED 206 to a photodiode 208 with an energy efficiency of, e.g., 0.1-0.5 picojoules per bit. In other embodiments, data can be transferred by a micro-LED 206 to a photodiode 208 with an energy efficiency of, e.g., less than 0.5-5 picojoules per bit. In an illustrative embodiment, the micro-LEDs 206 and photodiodes 208 can operate at a relatively wide temperature range, such as −40° C. to 125° C. The high maximum temperature can make the micro-LEDs 206 and photodiodes 208 suitable for operating adjacent a high-power semiconductor die 104, such as a processor die or GPU die.

The micro-LED assembly 212 may include the micro-LEDs 206 and photodiodes 208 in any suitable configuration, such as a linear array, a two-dimensional array, etc. The micro-LEDs 206 and photodiode 208 array may have any suitable size, such as an array with a length and/or width of 1-1,000 micro-LEDs 206 or photodiodes 208. In some embodiments, the micro-LEDs 206 and photodiodes 208 may be alternating, as shown in the figures. In other embodiments, micro-LEDs 206 may be grouped together (e.g., in a line or a two-dimensional array) and photodiodes 208 may be grouped together (e.g., in a line or a two-dimensional array).

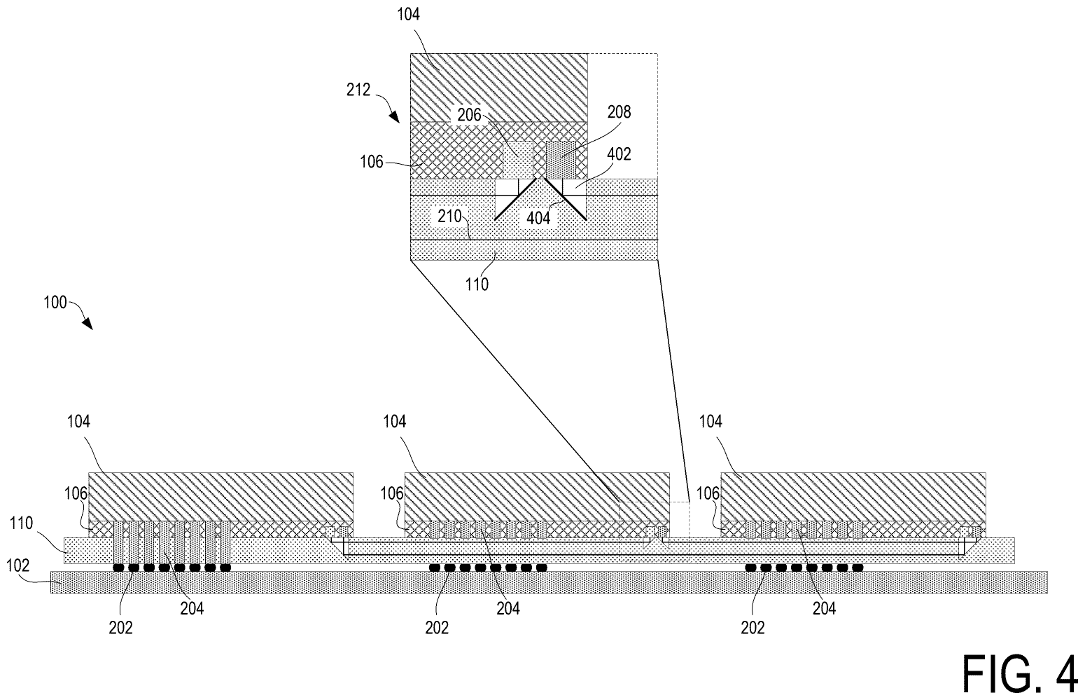

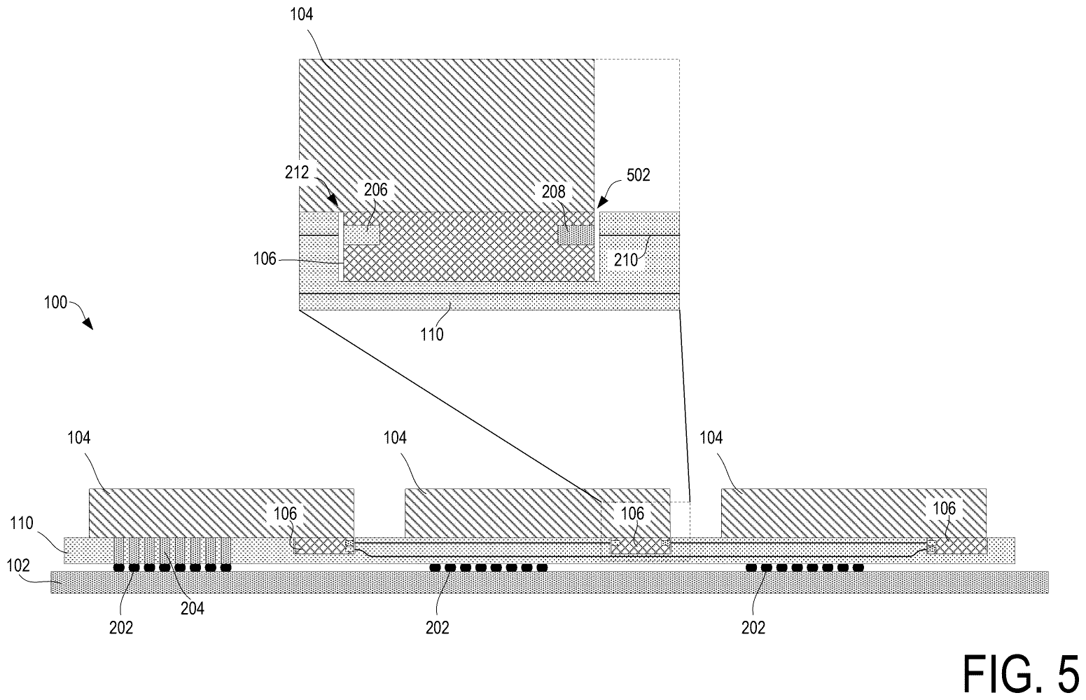

The glass interposer 110 may include any suitable number of waveguides 210 defined within it, such as 1-10,000 for each micro-LED assembly 212. The waveguides 210 may be any suitable waveguides 210, such as waveguides formed using direct laser writing or ion exchange. In an illustrative embodiment, the waveguides 210 are multi-mode fibers with a core diameter of, e.g., 50-100 micrometers. In other embodiments, the waveguides 210 may be single- or few-mode fibers with a core diameter of, e.g., 1-10 micrometers. In an illustrative embodiment, the waveguides 210 terminate at one end at the micro-LED assembly 212. The waveguides 210 may be coupled to the micro-LED assemblies 212 in any suitable manner, such as using butt-coupling, evanescent coupling, mirrors (see FIG. 4). The micro-LED assemblies 212 may direct light vertically into the glass interposer 110 as shown in FIG. 2, and/or the micro-LED assemblies 212 may direct light horizontally into the glass interposer 110, as shown in FIG. 5. It should be appreciated that the waveguides 210 can be routed in three-dimensions (i.e., up and down, across the page, and into and out of the page, from the perspective of FIGS. 3 and 4). The three-dimensional routing can allow for any micro-LED 206 to be coupled to any photodiode 208.

Referring now to FIG. 4, in one embodiment, one or more cavities 402 may be defined in the glass interposer 110 below each micro-LED assembly 212. The cavities 402 have an angled reflective surface 404 to reflect light from the micro-LED dies 206 to the waveguides 210 and reflect light from the waveguides 210 to the photodiode dies 208. The reflective surface 404 may be a metal layer, a dielectric stack, or any other suitable reflective surface. In some embodiments, the cavities 402 may be backfilled, such as with glass, plastic, an index-matching material, etc. In use, light emitted from the micro-LEDs 206 can be reflected off of the mirror 404 and coupled into a waveguide 210, and light from a waveguide 210 can be reflected off of the mirror 404 to a photodiode 208. In an illustrative embodiment, the mirror 404 is flat. In other embodiments, the mirror 404 may be concave, and the mirror 404 may focus the light into and out of the waveguides 210, micro-LEDs 206, and photodiodes 208.

Referring now to FIG. 5, in one embodiment, a cavity 502 may be defined in the glass interposer 110 for each of the micro-LED assemblies 212. In such an embodiment, the IC die 104 may be mounted directly on the glass interposer 110, and the micro-LED assembly 212 is adjacent the IC die 104. In some embodiments, the cavity 502 may be filled with an index-matching material to reduce back-reflections. In an illustrative embodiment, the micro-LED assembly 212 is smaller than the IC die 104, as shown in the figures. In some embodiments, the micro-LED assembly 212 may have a length and/or width that is the same as or larger than the IC die 104, with a corresponding length and/or width for the cavity 502.

It should be appreciated that the embodiments described above are some but not all of the envisioned embodiments, and other embodiments are envisioned as well. For example, in one embodiment, the micro-LEDs 206 and/or the photodiodes 208 may be mounted directly on the IC die 104, without the base die 106. In another embodiment, several micro-LEDs 206 and/or photodiodes 208 may be fabricated directly on a base die 106.

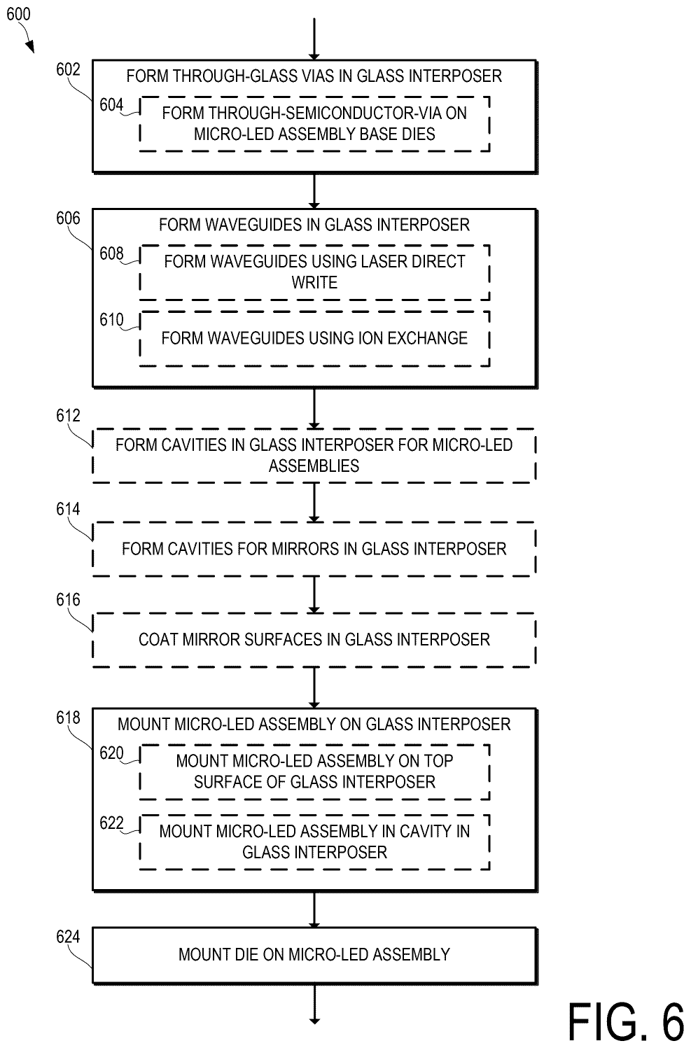

Referring now to FIG. 6, in one embodiment, a flowchart for a method 600 for creating an integrated circuit component is shown. The method 600 may be executed by a technician and/or by one or more automated machines. In some embodiments, one or more machines may be programmed to do some or all of the steps of the method 600. Such a machine may include, e.g., a memory, a processor, data storage, etc. The memory and/or data storage may store instructions that, when executed by the machine, cause the machine to perform some or all of the steps of the method 600. The method 600 may use any suitable set of techniques that are used in semiconductor processing, such as chemical vapor deposition, atomic layer deposition, physical layer deposition, molecular beam epitaxy, layer transfer, photolithography, ion implantation, dry etching, wet etching, thermal treatments, flip chip, layer transfer, magnetron sputter deposition, pulsed laser deposition, etc. It should be appreciated that the method 600 is merely one embodiment of a method to create various embodiments of the integrated circuit component 100, and other methods may be used to create the integrated circuit component 100. In some embodiments, steps of the method 600 may be performed in a different order than that shown in the flowchart.

The method 600 begins in block 602, in which through-glass vias 204 are formed in the glass interposer 110. In some embodiments, in block 604, through-silicon vias 204 may also be formed in the base dies 106.

In block 606, waveguides 210 are formed in the glass interposer 110. In some embodiments, in block 608, the waveguides 210 may be directly written in the glass interposer 110 using an ultrafast laser. Additionally or alternatively, in some embodiments, in block 610, the waveguides 210 may be formed using ion exchange.

In some embodiments, in block 612, cavities 502 may be formed in the glass interposer 110 for the micro-LED assemblies 212. The cavities 502 may be formed in any suitable manner, such as by using laser-assisted wet etching.

In some embodiments, in block 614, cavities 402 may be formed in the glass interposer 110 for the mirrors 404. The cavities 402 may be formed in any suitable manner, such as by using laser-assisted wet etching. In block 616, the mirrors 404 may be formed by coating the surface of the cavities 402.

In block 618, the micro-LED assemblies 212 are mounted on the glass interposer 110. In some embodiments, in block 620, the micro-LED assemblies 212 are mounted on the top surface of the glass interposer 110. In other embodiments, in block 622, the micro-LED assemblies 212 may be mounted in a cavity 502 defined in the glass interposer 110.

In block 624, an IC die 104 is mounted on the micro-LED assembly 212. In some embodiments, the micro-LED assembly 212 may be first mounted on the IC die 104, and the IC die 104 and micro-LED assembly 212 may be mounted on the glass interposer 110 together.

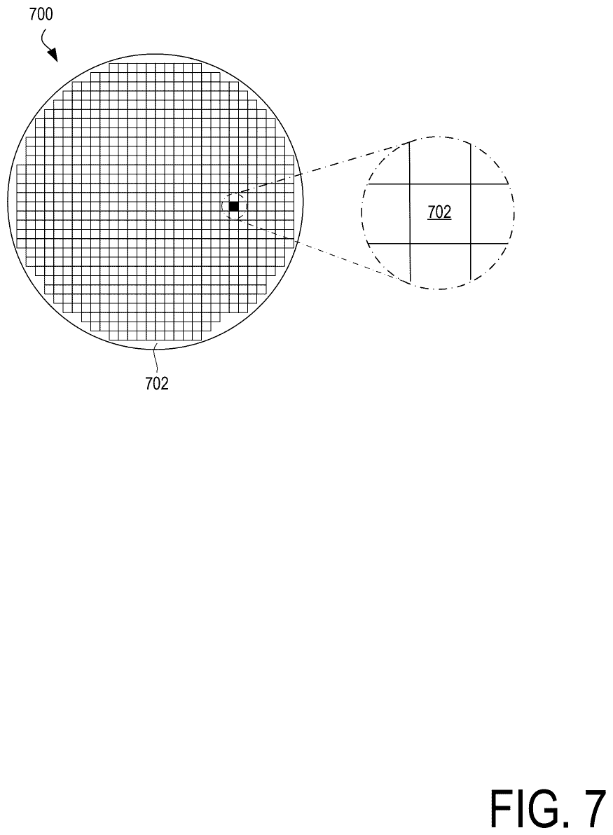

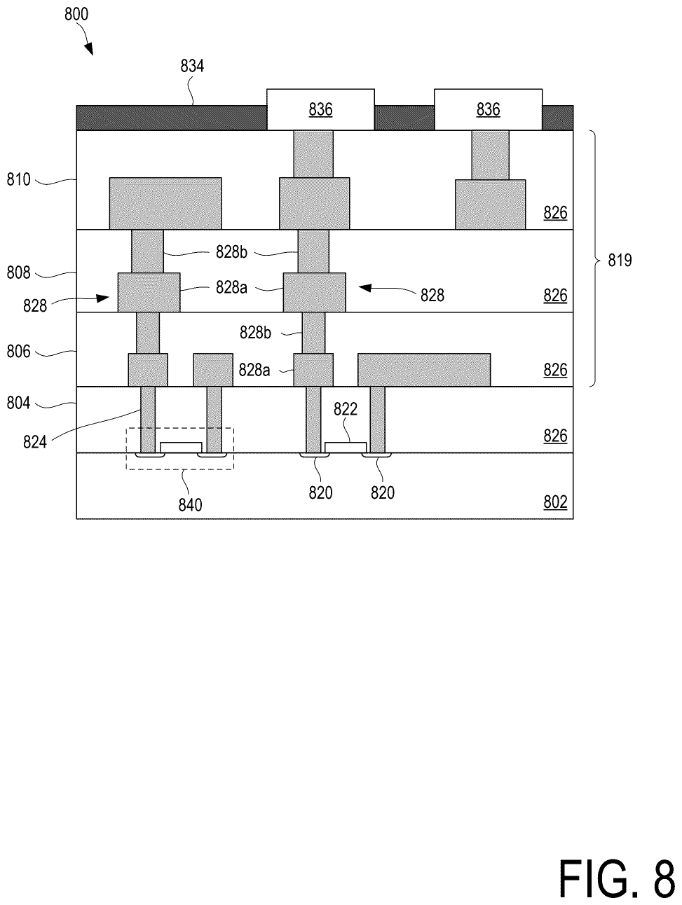

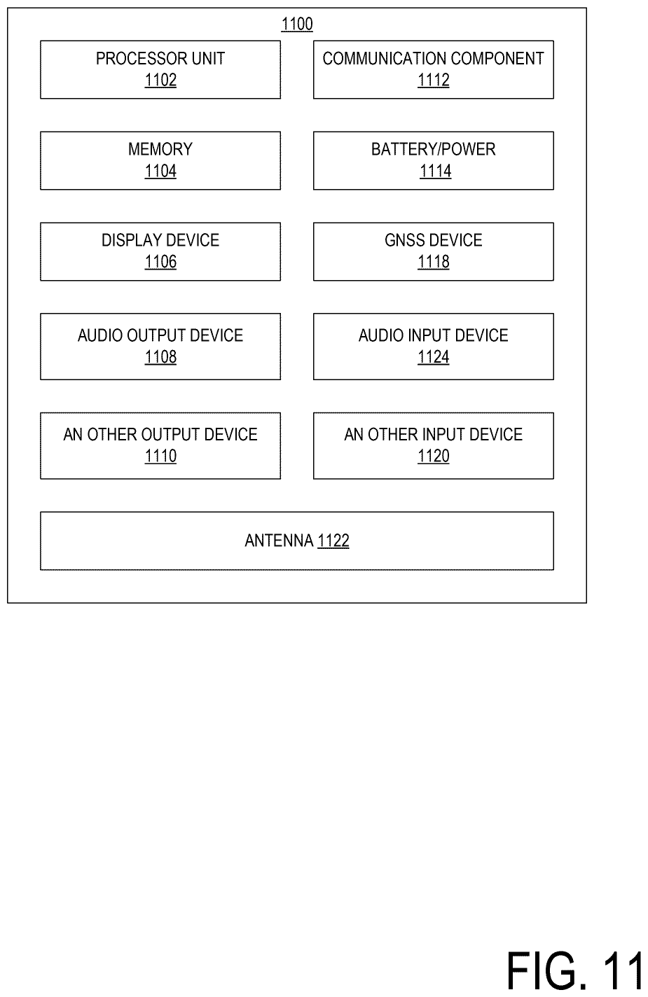

FIG. 7 is a top view of a wafer 700 and dies 702 that may be included in any of the integrated circuit components 100 disclosed herein (e.g., as any suitable ones of the dies 106, 108, 206, 208). The wafer 700 may be composed of semiconductor material and may include one or more dies 702 having integrated circuit structures formed on a surface of the wafer 700. The individual dies 702 may be a repeating unit of an integrated circuit product that includes any suitable integrated circuit. After the fabrication of the semiconductor product is complete, the wafer 700 may undergo a singulation process in which the dies 702 are separated from one another to provide discrete “chips” of the integrated circuit product. The die 702 may be any of the dies 106, 108, 206, 208 disclosed herein. The die 702 may include one or more transistors (e.g., some of the transistors 840 of FIG. 8, discussed below), supporting circuitry to route electrical signals to the transistors, passive components (e.g., signal traces, resistors, capacitors, or inductors), and/or any other integrated circuit components. In some embodiments, the wafer 700 or the die 702 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 702. For example, a memory array formed by multiple memory devices may be formed on a same die 702 as a processor unit (e.g., the processor unit 1102 of FIG. 11) or other logic that is configured to store information in the memory devices or execute instructions stored in the memory array. Various ones of the integrated circuit components 100 disclosed herein may be manufactured using a die-to-wafer assembly technique in which some dies 106, 108, 206, 208 are attached to a wafer 700 that include others of the dies 106, 108, 206, 208 and the wafer 700 is subsequently singulated.

FIG. 8 is a cross-sectional side view of an integrated circuit device 800 that may be included in any of the integrated circuit components 100 disclosed herein (e.g., in any of the dies 106, 108, 206, 208). One or more of the integrated circuit devices 800 may be included in one or more dies 702 (FIG. 7). The integrated circuit device 800 may be formed on a die substrate 802 (e.g., the wafer 700 of FIG. 7) and may be included in a die (e.g., the die 702 of FIG. 7). The die substrate 802 may be a semiconductor substrate composed of semiconductor material systems including, for example, n-type or p-type materials systems (or a combination of both). The die substrate 802 may include, for example, a crystalline substrate formed using a bulk silicon or a silicon-on-insulator (SOI) substructure. In some embodiments, the die substrate 802 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 802. Although a few examples of materials from which the die substrate 802 may be formed are described here, any material that may serve as a foundation for an integrated circuit device 800 may be used. The die substrate 802 may be part of a singulated die (e.g., the dies 702 of FIG. 7) or a wafer (e.g., the wafer 700 of FIG. 7).

The integrated circuit device 800 may include one or more device layers 804 disposed on the die substrate 802. The device layer 804 may include features of one or more transistors 840 (e.g., metal oxide semiconductor field-effect transistors (MOSFETs)) formed on the die substrate 802. The transistors 840 may include, for example, one or more source and/or drain (S/D) regions 820, a gate 822 to control current flow between the S/D regions 820, and one or more S/D contacts 824 to route electrical signals to/from the S/D regions 820. The transistors 840 may include additional features not depicted for the sake of clarity, such as device isolation regions, gate contacts, and the like. The transistors 840 are not limited to the type and configuration depicted in FIG. 8 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

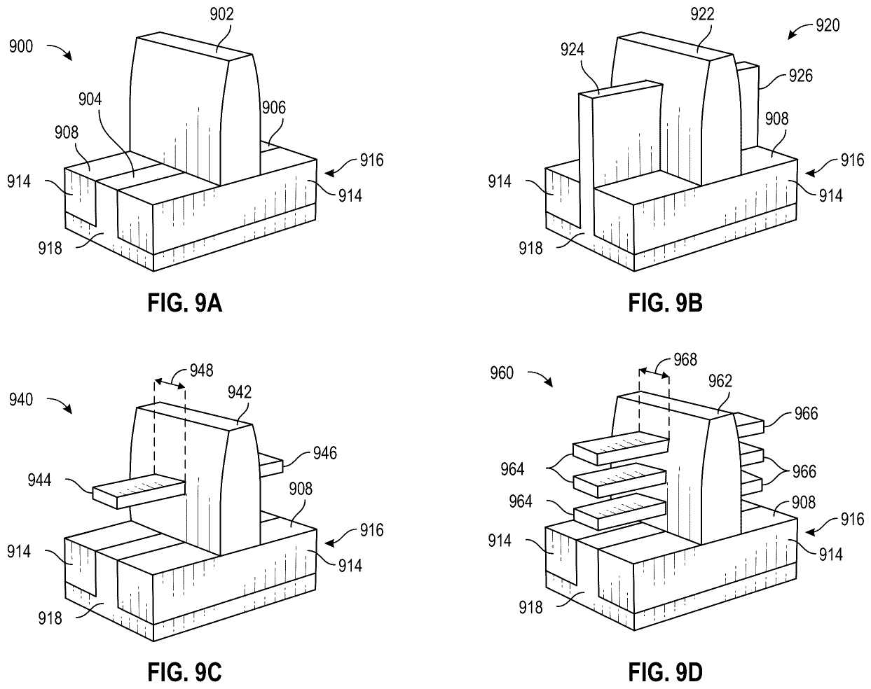

FIGS. 9A-9D are simplified perspective views of example planar, FinFET, gate-all-around, and stacked gate-all-around transistors. The transistors illustrated in FIGS. 9A-9D are formed on a substrate 916 having a surface 908. Isolation regions 914 separate the source and drain regions of the transistors from other transistors and from a bulk region 918 of the substrate 916.

FIG. 9A is a perspective view of an example planar transistor 900 comprising a gate 902 that controls current flow between a source region 904 and a drain region 906. The transistor 900 is planar in that the source region 904 and the drain region 906 are planar with respect to the substrate surface 908.

FIG. 9B is a perspective view of an example FinFET transistor 920 comprising a gate 922 that controls current flow between a source region 924 and a drain region 926. The transistor 920 is non-planar in that the source region 924 and the drain region 926 comprise “fins” that extend upwards from the substrate surface 928. As the gate 922 encompasses three sides of the semiconductor fin that extends from the source region 924 to the drain region 926, the transistor 920 can be considered a tri-gate transistor. FIG. 9B illustrates one S/D fin extending through the gate 922, but multiple S/D fins can extend through the gate of a FinFET transistor.

FIG. 9C is a perspective view of a gate-all-around (GAA) transistor 940 comprising a gate 942 that controls current flow between a source region 944 and a drain region 946. The transistor 940 is non-planar in that the source region 944 and the drain region 946 are elevated from the substrate surface 928.

FIG. 9D is a perspective view of a GAA transistor 960 comprising a gate 962 that controls current flow between multiple elevated source regions 964 and multiple elevated drain regions 966. The transistor 960 is a stacked GAA transistor as the gate controls the flow of current between multiple elevated S/D regions stacked on top of each other. The transistors 940 and 960 are considered gate-all-around transistors as the gates encompass all sides of the semiconductor portions that extends from the source regions to the drain regions. The transistors 940 and 960 can alternatively be referred to as nanowire, nanosheet, or nanoribbon transistors depending on the width (e.g., widths 948 and 968 of transistors 940 and 960, respectively) of the semiconductor portions extending through the gate.

Returning to FIG. 8, a transistor 840 may include a gate 822 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 840 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 840 along the source-channel-drain direction, the gate electrode may consist of a U-shaped structure that includes a bottom portion substantially parallel to the surface of the die substrate 802 and two sidewall portions that are substantially perpendicular to the top surface of the die substrate 802. In other embodiments, at least one of the metal layers that form the gate electrode may simply be a planar layer that is substantially parallel to the top surface of the die substrate 802 and does not include sidewall portions substantially perpendicular to the top surface of the die substrate 802. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 820 may be formed within the die substrate 802 adjacent to the gate 822 of individual transistors 840. The S/D regions 820 may be formed using an implantation/diffusion process or an etching/deposition process, for example. In the former process, dopants such as boron, aluminum, antimony, phosphorous, or arsenic may be ion-implanted into the die substrate 802 to form the S/D regions 820. An annealing process that activates the dopants and causes them to diffuse farther into the die substrate 802 may follow the ion-implantation process. In the latter process, the die substrate 802 may first be etched to form recesses at the locations of the S/D regions 820. An epitaxial deposition process may then be carried out to fill the recesses with material that is used to fabricate the S/D regions 820. In some implementations, the S/D regions 820 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 820 may be formed using one or more alternate semiconductor materials such as germanium or a group III-V material or alloy. In further embodiments, one or more layers of metal and/or metal alloys may be used to form the S/D regions 820.

Electrical signals, such as power and/or input/output (I/O) signals, may be routed to and/or from the devices (e.g., transistors 840) of the device layer 804 through one or more interconnect layers disposed on the device layer 804 (illustrated in FIG. 8 as interconnect layers 806-810). For example, electrically conductive features of the device layer 804 (e.g., the gate 822 and the S/D contacts 824) may be electrically coupled with the interconnect structures 828 of the interconnect layers 806-810. The one or more interconnect layers 806-810 may form a metallization stack (also referred to as an “ILD stack”) 819 of the integrated circuit device 800.

The interconnect structures 828 may be arranged within the interconnect layers 806-810 to route electrical signals according to a wide variety of designs; in particular, the arrangement is not limited to the particular configuration of interconnect structures 828 depicted in FIG. 8. Although a particular number of interconnect layers 806-810 is depicted in FIG. 8, embodiments of the present disclosure include integrated circuit devices having more or fewer interconnect layers than depicted.

In some embodiments, the interconnect structures 828 may include lines 828a and/or vias 828b filled with an electrically conductive material such as a metal. The lines 828a may be arranged to route electrical signals in a direction of a plane that is substantially parallel with a surface of the die substrate 802 upon which the device layer 804 is formed. For example, the lines 828a may route electrical signals in a direction in and out of the page and/or in a direction across the page. The vias 828b may be arranged to route electrical signals in a direction of a plane that is substantially perpendicular to the surface of the die substrate 802 upon which the device layer 804 is formed. In some embodiments, the vias 828b may electrically couple lines 828a of different interconnect layers 806-810 together.

The interconnect layers 806-810 may include a dielectric material 826 disposed between the interconnect structures 828, as shown in FIG. 8. In some embodiments, dielectric material 826 disposed between the interconnect structures 828 in different ones of the interconnect layers 806-810 may have different compositions; in other embodiments, the composition of the dielectric material 826 between different interconnect layers 806-810 may be the same. The device layer 804 may include a dielectric material 826 disposed between the transistors 840 and a bottom layer of the metallization stack as well. The dielectric material 826 included in the device layer 804 may have a different composition than the dielectric material 826 included in the interconnect layers 806-810; in other embodiments, the composition of the dielectric material 826 in the device layer 804 may be the same as a dielectric material 826 included in any one of the interconnect layers 806-810.

A first interconnect layer 806 (referred to as Metal 1 or “M1”) may be formed directly on the device layer 804. In some embodiments, the first interconnect layer 806 may include lines 828a and/or vias 828b, as shown. The lines 828a of the first interconnect layer 806 may be coupled with contacts (e.g., the S/D contacts 824) of the device layer 804. The vias 828b of the first interconnect layer 806 may be coupled with the lines 828a of a second interconnect layer 808.

The second interconnect layer 808 (referred to as Metal 2 or “M2”) may be formed directly on the first interconnect layer 806. In some embodiments, the second interconnect layer 808 may include via 828b to couple the lines 828 of the second interconnect layer 808 with the lines 828a of a third interconnect layer 810. Although the lines 828a and the vias 828b are structurally delineated with a line within individual interconnect layers for the sake of clarity, the lines 828a and the vias 828b may be structurally and/or materially contiguous (e.g., simultaneously filled during a dual-damascene process) in some embodiments.

The third interconnect layer 810 (referred to as Metal 3 or “M3”) (and additional interconnect layers, as desired) may be formed in succession on the second interconnect layer 808 according to similar techniques and configurations described in connection with the second interconnect layer 808 or the first interconnect layer 806. In some embodiments, the interconnect layers that are “higher up” in the metallization stack 819 in the integrated circuit device 800 (i.e., farther away from the device layer 804) may be thicker that the interconnect layers that are lower in the metallization stack 819, with lines 828a and vias 828b in the higher interconnect layers being thicker than those in the lower interconnect layers.

The integrated circuit device 800 may include a solder resist material 834 (e.g., polyimide or similar material) and one or more conductive contacts 836 formed on the interconnect layers 806-810. In FIG. 8, the conductive contacts 836 are illustrated as taking the form of bond pads. The conductive contacts 836 may be electrically coupled with the interconnect structures 828 and configured to route the electrical signals of the transistor(s) 840 to external devices. For example, solder bonds may be formed on the one or more conductive contacts 836 to mechanically and/or electrically couple an integrated circuit die including the integrated circuit device 800 with another component (e.g., a printed circuit board). The integrated circuit device 800 may include additional or alternate structures to route the electrical signals from the interconnect layers 806-810; for example, the conductive contacts 836 may include other analogous features (e.g., posts) that route the electrical signals to external components.

In some embodiments in which the integrated circuit device 800 is a double-sided die, the integrated circuit device 800 may include another metallization stack (not shown) on the opposite side of the device layer(s) 804. This metallization stack may include multiple interconnect layers as discussed above with reference to the interconnect layers 806-810, to provide conductive pathways (e.g., including conductive lines and vias) between the device layer(s) 804 and additional conductive contacts (not shown) on the opposite side of the integrated circuit device 800 from the conductive contacts 836.

In other embodiments in which the integrated circuit device 800 is a double-sided die, the integrated circuit device 800 may include one or more through silicon vias (TSVs) through the die substrate 802; these TSVs may make contact with the device layer(s) 804, and may provide conductive pathways between the device layer(s) 804 and additional conductive contacts (not shown) on the opposite side of the integrated circuit device 800 from the conductive contacts 836. In some embodiments, TSVs extending through the substrate can be used for routing power and ground signals from conductive contacts on the opposite side of the integrated circuit device 800 from the conductive contacts 836 to the transistors 840 and any other components integrated into the die 800, and the metallization stack 819 can be used to route I/O signals from the conductive contacts 836 to transistors 840 and any other components integrated into the die 800.

Multiple integrated circuit devices 800 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

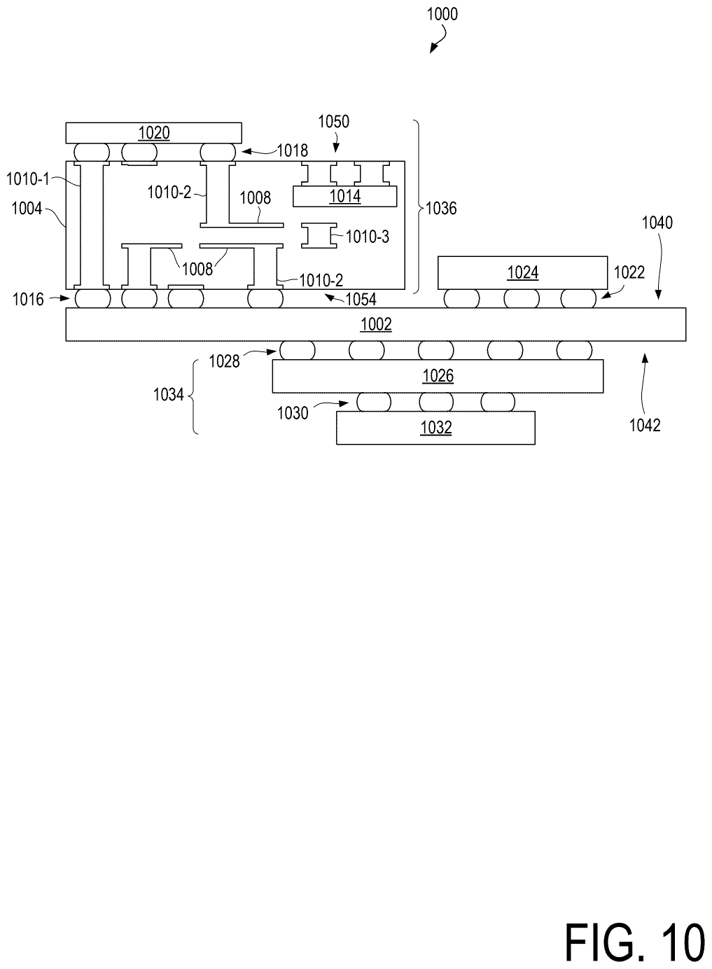

FIG. 10 is a cross-sectional side view of an integrated circuit device assembly 1000 that may include any of the integrated circuit components 100 disclosed herein. In some embodiments, the integrated circuit device assembly 1000 may be an integrated circuit components 100. The integrated circuit device assembly 1000 includes a number of components disposed on a circuit board 1002 (which may be a motherboard, system board, mainboard, etc.). The integrated circuit device assembly 1000 includes components disposed on a first face 1040 of the circuit board 1002 and an opposing second face 1042 of the circuit board 1002; generally, components may be disposed on one or both faces 1040 and 1042. Any of the integrated circuit components discussed below with reference to the integrated circuit device assembly 1000 may take the form of any suitable ones of the embodiments of the integrated circuit components 100 disclosed herein.

In some embodiments, the circuit board 1002 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1002. In other embodiments, the circuit board 1002 may be a non-PCB substrate. In some embodiments the circuit board 1002 may be, for example, the circuit board 102. The integrated circuit device assembly 1000 illustrated in FIG. 10 includes a package-on-interposer structure 1036 coupled to the first face 1040 of the circuit board 1002 by coupling components 1016. The coupling components 1016 may electrically and mechanically couple the package-on-interposer structure 1036 to the circuit board 1002, and may include solder balls (as shown in FIG. 10), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 1036 may include an integrated circuit component 1020 coupled to an interposer 1004 by coupling components 1018. The coupling components 1018 may take any suitable form for the application, such as the forms discussed above with reference to the coupling components 1016. Although a single integrated circuit component 1020 is shown in FIG. 10, multiple integrated circuit components may be coupled to the interposer 1004; indeed, additional interposers may be coupled to the interposer 1004. The interposer 1004 may provide an intervening substrate used to bridge the circuit board 1002 and the integrated circuit component 1020.

The integrated circuit component 1020 may be a packaged or unpacked integrated circuit product that includes one or more integrated circuit dies (e.g., the die 702 of FIG. 7, the integrated circuit device 800 of FIG. 8) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1020, a single monolithic integrated circuit die comprises solder bumps attached to contacts on the die. The solder bumps allow the die to be directly attached to the interposer 1004. The integrated circuit component 1020 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1020 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1020 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1020 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1004 may spread connections to a wider pitch or reroute a connection to a different connection. For example, the interposer 1004 may couple the integrated circuit component 1020 to a set of ball grid array (BGA) conductive contacts of the coupling components 1016 for coupling to the circuit board 1002. In the embodiment illustrated in FIG. 10, the integrated circuit component 1020 and the circuit board 1002 are attached to opposing sides of the interposer 1004; in other embodiments, the integrated circuit component 1020 and the circuit board 1002 may be attached to a same side of the interposer 1004. In some embodiments, three or more components may be interconnected by way of the interposer 1004.

In some embodiments, the interposer 1004 may be formed as a PCB, including multiple metal layers separated from one another by layers of dielectric material and interconnected by electrically conductive vias. In some embodiments, the interposer 1004 may be formed of an epoxy resin, a fiberglass-reinforced epoxy resin, an epoxy resin with inorganic fillers, a ceramic material, or a polymer material such as polyimide. In some embodiments, the interposer 1004 may be formed of alternate rigid or flexible materials that may include the same materials described above for use in a semiconductor substrate, such as silicon, germanium, and other group III-V and group IV materials. The interposer 1004 may include metal interconnects 1008 and vias 1010, including but not limited to through hole vias 1010-1 (that extend from a first face 1050 of the interposer 1004 to a second face 1054 of the interposer 1004), blind vias 1010-2 (that extend from the first or second faces 1050 or 1054 of the interposer 1004 to an internal metal layer), and buried vias 1010-3 (that connect internal metal layers).

In some embodiments, the interposer 1004 can comprise a silicon interposer. Through silicon vias (TSV) extending through the silicon interposer can connect connections on a first face of a silicon interposer to an opposing second face of the silicon interposer. In some embodiments, an interposer 1004 comprising a silicon interposer can further comprise one or more routing layers to route connections on a first face of the interposer 1004 to an opposing second face of the interposer 1004.

The interposer 1004 may further include embedded devices 1014, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1004. The package-on-interposer structure 1036 may take the form of any of the package-on-interposer structures known in the art.

The integrated circuit device assembly 1000 may include an integrated circuit component 1024 coupled to the first face 1040 of the circuit board 1002 by coupling components 1022. The coupling components 1022 may take the form of any of the embodiments discussed above with reference to the coupling components 1016, and the integrated circuit component 1024 may take the form of any of the embodiments discussed above with reference to the integrated circuit component 1020.

The integrated circuit device assembly 1000 illustrated in FIG. 10 includes a package-on-package structure 1034 coupled to the second face 1042 of the circuit board 1002 by coupling components 1028. The package-on-package structure 1034 may include an integrated circuit component 1026 and an integrated circuit component 1032 coupled together by coupling components 1030 such that the integrated circuit component 1026 is disposed between the circuit board 1002 and the integrated circuit component 1032. The coupling components 1028 and 1030 may take the form of any of the embodiments of the coupling components 1016 discussed above, and the integrated circuit components 1026 and 1032 may take the form of any of the embodiments of the integrated circuit component 1020 discussed above. The package-on-package structure 1034 may be configured in accordance with any of the package-on-package structures known in the art.

FIG. 11 is a block diagram of an example electrical device 1100 that may include one or more of the integrated circuit components 100 disclosed herein. For example, any suitable ones of the components of the electrical device 1100 may include one or more of the integrated circuit device assemblies 1000, integrated circuit components 1020, integrated circuit devices 800, or integrated circuit dies 702 disclosed herein, and may be arranged in any of the integrated circuit components 100 disclosed herein. A number of components are illustrated in FIG. 11 as included in the electrical device 1100, but any one or more of these components may be omitted or duplicated, as suitable for the application. In some embodiments, some or all of the components included in the electrical device 1100 may be attached to one or more motherboards mainboards, or system boards. In some embodiments, one or more of these components are fabricated onto a single system-on-a-chip (SoC) die.

Additionally, in various embodiments, the electrical device 1100 may not include one or more of the components illustrated in FIG. 11, but the electrical device 1100 may include interface circuitry for coupling to the one or more components. For example, the electrical device 1100 may not include a display device 1106, but may include display device interface circuitry (e.g., a connector and driver circuitry) to which a display device 1106 may be coupled. In another set of examples, the electrical device 1100 may not include an audio input device 1124 or an audio output device 1108, but may include audio input or output device interface circuitry (e.g., connectors and supporting circuitry) to which an audio input device 1124 or audio output device 1108 may be coupled.

The electrical device 1100 may include one or more processor units 1102 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1102 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1100 may include a memory 1104, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1104 may include memory that is located on the same integrated circuit die as the processor unit 1102. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1100 can comprise one or more processor units 1102 that are heterogeneous or asymmetric to another processor unit 1102 in the electrical device 1100. There can be a variety of differences between the processing units 1102 in a system in terms of a spectrum of metrics of merit including architectural, microarchitectural, thermal, power consumption characteristics, and the like. These differences can effectively manifest themselves as asymmetry and heterogeneity among the processor units 1102 in the electrical device 1100.

In some embodiments, the electrical device 1100 may include a communication component 1112 (e.g., one or more communication components). For example, the communication component 1112 can manage wireless communications for the transfer of data to and from the electrical device 1100. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1112 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1112 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1112 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1112 may operate in accordance with other wireless protocols in other embodiments. The electrical device 1100 may include an antenna 1122 to facilitate wireless communications and/or to receive other wireless communications (such as AM or FM radio transmissions).

In some embodiments, the communication component 1112 may manage wired communications, such as electrical, optical, or any other suitable communication protocols (e.g., IEEE 802.3 Ethernet standards). As noted above, the communication component 1112 may include multiple communication components. For instance, a first communication component 1112 may be dedicated to shorter-range wireless communications such as Wi-Fi or Bluetooth, and a second communication component 1112 may be dedicated to longer-range wireless communications such as global positioning system (GPS), EDGE, GPRS, CDMA, WiMAX, LTE, EV-DO, or others. In some embodiments, a first communication component 1112 may be dedicated to wireless communications, and a second communication component 1112 may be dedicated to wired communications.

The electrical device 1100 may include battery/power circuitry 1114. The battery/power circuitry 1114 may include one or more energy storage devices (e.g., batteries or capacitors) and/or circuitry for coupling components of the electrical device 1100 to an energy source separate from the electrical device 1100 (e.g., AC line power).

The electrical device 1100 may include a display device 1106 (or corresponding interface circuitry, as discussed above). The display device 1106 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1100 may include an audio output device 1108 (or corresponding interface circuitry, as discussed above). The audio output device 1108 may include any embedded or wired or wirelessly connected external device that generates an audible indicator, such as speakers, headsets, or earbuds.

The electrical device 1100 may include an audio input device 1124 (or corresponding interface circuitry, as discussed above). The audio input device 1124 may include any embedded or wired or wirelessly connected device that generates a signal representative of a sound, such as microphones, microphone arrays, or digital instruments (e.g., instruments having a musical instrument digital interface (MIDI) output). The electrical device 1100 may include a Global Navigation Satellite System (GNSS) device 1118 (or corresponding interface circuitry, as discussed above), such as a Global Positioning System (GPS) device. The GNSS device 1118 may be in communication with a satellite-based system and may determine a geolocation of the electrical device 1100 based on information received from one or more GNSS satellites, as known in the art.

The electrical device 1100 may include an other output device 1110 (or corresponding interface circuitry, as discussed above). Examples of the other output device 1110 may include an audio codec, a video codec, a printer, a wired or wireless transmitter for providing information to other devices, or an additional storage device.

The electrical device 1100 may include an other input device 1120 (or corresponding interface circuitry, as discussed above). Examples of the other input device 1120 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1100 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1100 may be any other electronic device that processes data. In some embodiments, the electrical device 1100 may comprise multiple discrete physical components. Given the range of devices that the electrical device 1100 can be manifested as in various embodiments, in some embodiments, the electrical device 1100 can be referred to as a computing device or a computing system.

### EXAMPLES

Illustrative examples of the technologies disclosed herein are provided below. An embodiment of the technologies may include any one or more, and any combination of, the examples described below.

Example 1 includes an apparatus comprising an integrated circuit die; a micro-light-emitting diode (micro-LED) assembly comprising one or more micro-LEDs; wherein the micro-LED assembly is mounted on the integrated circuit die; and a glass interposer, wherein one or more waveguides are defined in the glass interposer, wherein the one or more waveguides terminate at the micro-LED assembly.

Example 2 includes the subject matter of Example 1, and wherein the micro-LED assembly is mounted on the glass interposer, wherein the integrated circuit die is mounted on the micro-LED assembly.

Example 3 includes the subject matter of any of Examples 1 and 2, and wherein the one or more waveguides are butt coupled to the one or more micro-LEDs.

Example 4 includes the subject matter of any of Examples 1-3, and wherein the one or more waveguides are evanescently coupled to the one or more micro-LEDs.

Example 5 includes the subject matter of any of Examples 1-4, and wherein one or more mirrors are defined in the glass interposer, wherein the one or more waveguides are coupled to the one or more micro-LEDs by the one or more mirrors.

Example 6 includes the subject matter of any of Examples 1-5, and wherein a cavity is defined in the glass interposer, wherein the micro-LED assembly is disposed in the cavity of the glass interposer.

Example 7 includes the subject matter of any of Examples 1-6, and further including an index-matching material disposed within the cavity.

Example 8 includes the subject matter of any of Examples 1-7, and wherein a plurality of through-glass vias are defined in the glass interposer, wherein the plurality of through-glass vias carry input signals, output signals, and power signals to or from the integrated circuit die.

Example 9 includes the subject matter of any of Examples 1-8, and wherein the micro-LED assembly comprises a base die, one or more micro-LED dies, and one or more photodiode dies.

Example 10 includes the subject matter of any of Examples 1-9, and wherein driver circuitry for the micro-LED assembly is located on the integrated circuit die.

Example 11 includes the subject matter of any of Examples 1-10, and wherein driver circuitry for the micro-LED assembly is located on the base die.

Example 12 includes the subject matter of any of Examples 1-11, and further including a second integrated circuit die; and a second micro-LED assembly, wherein the second micro-LED assembly is mounted on the second integrated circuit die, wherein the one or more waveguides are configured to carry light between the micro-LED assembly and the second micro-LED assembly.

Example 13 includes the subject matter of any of Examples 1-12, and further including a third integrated circuit die; and a third micro-LED assembly, wherein the third micro-LED assembly is mounted on the third integrated circuit die, wherein the one or more waveguides are configured to carry light between the micro-LED assembly and the third micro-LED assembly, wherein the one or more waveguides are configured to carry light between the second micro-LED assembly and the third micro-LED assembly.

Example 14 includes the subject matter of any of Examples 1-13, and further including a circuit board, wherein the glass interposer is mounted on the circuit board.

Example 15 includes the subject matter of any of Examples 1-14, and wherein the one or more micro-LEDs comprise gallium and nitrogen.

Example 16 includes the subject matter of any of Examples 1-15, and wherein the micro-LED assembly further comprises one or more photodiodes.

Example 17 includes the subject matter of any of Examples 1-16, and further including driver circuitry, wherein the driver circuitry is to modulate an amplitude of the one or more micro-LEDs at a rate of at least one gigahertz.

Example 18 includes the subject matter of any of Examples 1-17, and further including driver circuitry, wherein the driver circuitry is to modulate an amplitude of the one or more micro-LEDs at a rate of at least five gigahertz.

Example 19 includes an apparatus comprising an integrated circuit die; a glass interposer, wherein one or more waveguides are defined in the glass interposer; and a micro-light-emitting diode (micro-LED) assembly comprising one or more micro-LEDs; wherein the micro-LED assembly is adjacent to the integrated circuit die and the glass interposer, wherein, in use, light from the one or more micro-LEDs is coupled to the one or more waveguides.

Example 20 includes the subject matter of Example 19, and wherein the micro-LED assembly is mounted on the glass interposer, wherein the integrated circuit die is mounted on the micro-LED assembly.

Example 21 includes the subject matter of any of Examples 19 and 20, and wherein the one or more waveguides are butt coupled to the one or more micro-LEDs.

Example 22 includes the subject matter of any of Examples 19-21, and wherein the one or more waveguides are evanescently coupled to the one or more micro-LEDs.

Example 23 includes the subject matter of any of Examples 19-22, and wherein one or more mirrors are defined in the glass interposer, wherein the one or more waveguides are coupled to the one or more micro-LEDs by the one or more mirrors.

Example 24 includes the subject matter of any of Examples 19-23, and wherein a cavity is defined in the glass interposer, wherein the micro-LED assembly is disposed in the cavity of the glass interposer.

Example 25 includes the subject matter of any of Examples 19-24, and further including an index-matching material disposed within the cavity.

Example 26 includes the subject matter of any of Examples 19-25, and wherein a plurality of through-glass vias are defined in the glass interposer, wherein the plurality of through-glass vias carry input signals, output signals, and power signals to or from the integrated circuit die.

Example 27 includes the subject matter of any of Examples 19-26, and wherein the micro-LED assembly comprises a base die, one or more micro-LED dies, and one or more photodiode dies.

Example 28 includes the subject matter of any of Examples 19-27, and wherein driver circuitry for the micro-LED assembly is located on the integrated circuit die.

Example 29 includes the subject matter of any of Examples 19-28, and wherein driver circuitry for the micro-LED assembly is located on the base die.

Example 30 includes the subject matter of any of Examples 19-29, and further including a second integrated circuit die; and a second micro-LED assembly, wherein the second micro-LED assembly is mounted on the second integrated circuit die, wherein the one or more waveguides are configured to carry light between the micro-LED assembly and the second micro-LED assembly.

Example 31 includes the subject matter of any of Examples 19-30, and further including a third integrated circuit die; and a third micro-LED assembly, wherein the third micro-LED assembly is mounted on the third integrated circuit die, wherein the one or more waveguides are configured to carry light between the micro-LED assembly and the third micro-LED assembly, wherein the one or more waveguides are configured to carry light between the second micro-LED assembly and the third micro-LED assembly.

Example 32 includes the subject matter of any of Examples 19-31, and further including a circuit board, wherein the glass interposer is mounted on the circuit board.

Example 33 includes the subject matter of any of Examples 19-32, and wherein the one or more micro-LEDs comprise gallium and nitrogen.

Example 34 includes the subject matter of any of Examples 19-33, and wherein the micro-LED assembly further comprises one or more photodiodes.

Example 35 includes the subject matter of any of Examples 19-34, and further including driver circuitry, wherein the driver circuitry is to modulate an amplitude of the one or more micro-LEDs at a rate of at least one gigahertz.

Example 36 includes the subject matter of any of Examples 19-35, and further including driver circuitry, wherein the driver circuitry is to modulate an amplitude of the one or more micro-LEDs at a rate of at least five gigahertz.

Example 37 includes an apparatus comprising a glass interposer, wherein one or more waveguides are defined in the glass interposer; an integrated circuit die; and means for converting electrical signals from the integrated circuit die to optical signals, wherein the means for converting electrical signals from the integrated circuit die to optical signals is adjacent to the glass interposer and the integrated circuit die.

Example 38 includes the subject matter of Example 37, and wherein the means for converting electrical signals is mounted on the glass interposer, wherein the integrated circuit die is mounted on the means for converting electrical signals.

Example 39 includes the subject matter of any of Examples 37 and 38, and wherein the one or more waveguides are butt coupled to the means for converting electrical signals.

Example 40 includes the subject matter of any of Examples 37-39, and wherein the one or more waveguides are evanescently coupled to means for converting electrical signals.

Example 41 includes the subject matter of any of Examples 37-40, and wherein one or more mirrors are defined in the glass interposer, wherein the one or more waveguides are coupled to the means for converting electrical signals by the one or more mirrors.

Example 42 includes the subject matter of any of Examples 37-41, and wherein a cavity is defined in the glass interposer, wherein the means for converting electrical signals is disposed in the cavity of the glass interposer.

Example 43 includes the subject matter of any of Examples 37-42, and further including an index-matching material disposed within the cavity.

Example 44 includes the subject matter of any of Examples 37-43, and wherein a plurality of through-glass vias are defined in the glass interposer, wherein the plurality of through-glass vias carry input signals, output signals, and power signals to or from the integrated circuit die.

Example 45 includes the subject matter of any of Examples 37-44, and wherein the means for converting electrical signals comprises a base die, one or more micro-LED dies, and one or more photodiode dies.

Example 46 includes the subject matter of any of Examples 37-45, and wherein driver circuitry for means for converting electrical signals is located on the integrated circuit die.

Example 47 includes the subject matter of any of Examples 37-46, and wherein driver circuitry for the means for converting electrical signals is located within the means for converting electrical signals.

Example 48 includes the subject matter of any of Examples 37-47, and further including a second integrated circuit die; and a second means for converting electrical signals, wherein the second means for converting electrical signals is mounted on the second integrated circuit die, wherein the one or more waveguides are configured to carry light between the means for converting electrical signals and the means for converting electrical signals.

Example 49 includes the subject matter of any of Examples 37-48, and further including a third integrated circuit die; and a third means for converting electrical signals, wherein the third means for converting electrical signals is mounted on the third integrated circuit die, wherein the one or more waveguides are configured to carry light between the means for converting electrical signals and the third means for converting electrical signals, wherein the one or more waveguides are configured to carry light between the second means for converting electrical signals and the third means for converting electrical signals.

Example 50 includes the subject matter of any of Examples 37-49, and further including a circuit board, wherein the glass interposer is mounted on the circuit board.

Example 51 includes the subject matter of any of Examples 37-50, and wherein the means for converting electrical signals comprise gallium and nitrogen.

Example 52 includes the subject matter of any of Examples 37-51, and wherein the means for converting electrical signals comprises one or more photodiodes.

Example 53 includes the subject matter of any of Examples 37-52, and further including driver circuitry, wherein the driver circuitry is to modulate an amplitude of an output of the means for converting electrical signals at a rate of at least one gigahertz.

Example 54 includes the subject matter of any of Examples 37-53, and further including driver circuitry, wherein the driver circuitry is to modulate an amplitude of an output of the means for converting electrical signals at a rate of at least five gigahertz.

1. An apparatus comprising:
an integrated circuit die;
a micro-light-emitting diode (micro-LED) assembly comprising one or more micro-LEDs; wherein the micro-LED assembly is mounted on the integrated circuit die; and
a glass interposer, wherein one or more waveguides are defined in the glass interposer, wherein the one or more waveguides terminate at the micro-LED assembly.

2. The apparatus of claim 1, wherein the micro-LED assembly is mounted on the glass interposer, wherein the integrated circuit die is mounted on the micro-LED assembly.

3. The apparatus of claim 2, wherein the one or more waveguides are butt coupled to the one or more micro-LEDs.

4. The apparatus of claim 2, wherein the one or more waveguides are evanescently coupled to the one or more micro-LEDs.

5. The apparatus of claim 1, wherein one or more mirrors are defined in the glass interposer, wherein the one or more waveguides are coupled to the one or more micro-LEDs by the one or more mirrors.

6. The apparatus of claim 1, wherein a cavity is defined in the glass interposer, wherein the micro-LED assembly is disposed in the cavity of the glass interposer.

7. The apparatus of claim 6, further comprising an index-matching material disposed within the cavity.

8. The apparatus of claim 1, wherein a plurality of through-glass vias are defined in the glass interposer, wherein the plurality of through-glass vias carry input signals, output signals, and power signals to or from the integrated circuit die.

9. The apparatus of claim 1, wherein the micro-LED assembly comprises a base die, one or more micro-LED dies, and one or more photodiode dies.

10. The apparatus of claim 9, wherein driver circuitry for the micro-LED assembly is located on the micro-LED assembly.

11. The apparatus of claim 1, further comprising:
a second integrated circuit die; and
a second micro-LED assembly, wherein the second micro-LED assembly is mounted on the second integrated circuit die,
wherein the one or more waveguides are configured to carry light between the micro-LED assembly and the second micro-LED assembly.

12. The apparatus of claim 1, further comprising a circuit board, wherein the glass interposer is mounted on the circuit board.

13. The apparatus of claim 1, wherein the one or more micro-LEDs comprise gallium and nitrogen.

14. An apparatus comprising:
an integrated circuit die;
a glass interposer, wherein one or more waveguides are defined in the glass interposer; and
a micro-light-emitting diode (micro-LED) assembly comprising one or more micro-LEDs; wherein the micro-LED assembly is adjacent to the integrated circuit die and the glass interposer,
wherein, in use, light from the one or more micro-LEDs is coupled to the one or more waveguides.

15. The apparatus of claim 14, wherein the micro-LED assembly is mounted on the glass interposer, wherein the integrated circuit die is mounted on the micro-LED assembly.

16. The apparatus of claim 14, wherein a plurality of through-glass vias are defined in the glass interposer, wherein the plurality of through-glass vias carry input signals, output signals, and power signals to or from the integrated circuit die.

17. The apparatus of claim 14, further comprising driver circuitry, wherein the driver circuitry is to modulate an amplitude of the one or more micro-LEDs at a rate of at least five gigahertz.

18. An apparatus comprising:
a glass interposer, wherein one or more waveguides are defined in the glass interposer;
an integrated circuit die; and
means for converting electrical signals from the integrated circuit die to optical signals, wherein the means for converting electrical signals from the integrated circuit die to optical signals is adjacent to the glass interposer and the integrated circuit die.

19. The apparatus of claim 18, wherein the means for converting electrical signals is mounted on the glass interposer, wherein the integrated circuit die is mounted on the means for converting electrical signals.

20. The apparatus of claim 18, wherein one or more mirrors are defined in the glass interposer, wherein the one or more waveguides are coupled to the means for converting electrical signals by the one or more mirrors.
